(19) United States
(12) Patent Application Publication
(10) Pub. No.: US 2025/0269591 A1
(43) Pub. Date: Aug. 28, 2025

(54) SHAPING DEVICE, SHAPING DEVICE MAINTENANCE METHOD, AND SHAPING METHOD

(71) Applicant: MIMAKI ENGINEERING CO., LTD., Nagano (JP)

(72) Inventors: Masayuki Furuse, Nagano (JP); Kenji Harayama, Nagano (JP); Yoshikazu Furukawa, Nagano (JP)

(73) Assignee: MIMAKI ENGINEERING CO., LTD., Nagano (JP)

(21) Appl. No.: 18/689,075

(22) PCT Filed: Sep. 15, 2022
(86) PCT No.: PCT/JP2022/034527

§ 371 Date: Aug. 9, 2024

(30) Foreign Application Priority Data
Sep. 21, 2021 (JP) 2021-152976

(51) Int. Cl. B29C 64/209; B29C 64/112; B29C 64/336; B33Y 10/00; B33Y 30/00

(52) U.S. Cl. CPC B29C 64/209; B29C 64/112; B29C 64/336; B33Y 10/00; B33Y 30/00

(57) ABSTRACT

To appropriately realize a configuration suitable for a shaping device that shapes a colored shaped object. A shaping device that shapes a shaped object in which at least a part is colored, includes a plurality of head units and a carriage. Each head unit includes a plurality of nozzle rows each of which ejects ink supplied from an ink container through supply paths of ink different from each other. The carriage holds, as the plurality of head units, a head unit that is a first head unit head including a plurality of nozzle rows each of which ejects colored ink of different colors, and a head unit that is a second head unit including a plurality of nozzle rows each of which ejects ink different from the colored ink ejected by the head unit.

### TECHNICAL FIELD

The present invention relates to a shaping device, a maintenance method of the shaping device, and a shaping method.

### BACKGROUND ART

Conventionally, a shaping device (3D printer) that shapes a shaped object using an inkjet head is known (see, for example, Patent Literature 1). In such a shaping device, a shaped object is shaped by a layered shaping method by layering a plurality of layers of ink formed by the inkjet head.

### CITATION LIST

### Patent Literature

Patent Literature 1: Japanese Unexamined Patent Publication No. 2015-071282

### SUMMARY OF INVENTION

### Technical Problems

When shaping a shaped object using the inkjet head, a shaped object colored with various colors can be shaped by using colored inks (color inks) of a plurality of colors. However, in this case, problems such as an increase in size and an increase in weight of the carriage for holding the inkjet head easily occur as the number of colors of ink to use increases. Therefore, conventionally, it has been desired to appropriately realize a configuration suitable for a shaping device that shapes a colored shaped object. Therefore, an object of the present invention is to provide a shaping device, a maintenance method of the shaping device, and a shaping method that can solve the above problems.

### Solutions to Problems

The inventors of the present application considered using a head unit that ejects a plurality of types of inks instead of an inkjet head that is configured individually for each type of ink (for example, for each color and for each use) as a configuration for ejecting the ink in the shaping device. According to such configuration, the miniaturization and weight reduction of the carriage can be appropriately realized as compared with the case of using the plurality of individual inkjet heads for each type of ink. However, in this case, at the time of maintenance of the shaping device, the head unit corresponding to the plurality of types of ink becomes a unit of replacement of components. In this case, when some types of ink cannot be appropriately ejected in the head unit, the head unit needs to be replaced even if there is no problem in ejecting other inks. In addition, as a result, there is a possibility that the cost of replacement of the components greatly increases.

In this regard, the inventors of the present application have focused on the fact that, among the plurality of types of ink ejected from one head unit, a portion related to the ink consumed more at the time of shaping becomes in a state requiring replacement at an earlier timing. Then, the inventors have considered selecting a plurality of types of ink ejected from one head unit so as to reduce the difference in the amount of ink consumed at the time of shaping. Furthermore, as a configuration for this purpose, consideration is made to using a plurality of head units to eject ink having a relatively small consumption amount from the first head unit and to eject the other ink from the second head unit. According to such configuration, the difference in the consumption amount can be appropriately reduced for the plurality of types of inks ejected from one head unit. Furthermore, in this case, it is conceivable that the portion corresponding to each type of ink in the same head unit becomes in a state in which replacement is required at the same time. Therefore, according to such configuration, the head unit can be hardly replaced in a state where only a part of the head unit is deteriorated.

When shaping a colored shaped object, the coloring region may be usually formed only on the surface of the shaped object. In this case, the consumption amount of the colored ink (color ink) used for forming the coloring region is significantly smaller than, for example, the ink used for forming the interior of the shaped object. Thus, in this case, consideration is made to ejecting the colored ink used for forming the coloring region from the first head unit and ejecting the other ink from the second head unit. With this configuration, when the head unit is used, the head unit can be replaced more appropriately. Thus, a configuration suitable for the shaping device that shapes the colored shaped object can be appropriately realized.

In addition, the inventor of the present application has found features necessary for obtaining such effects through further intensive research, and has reached the present invention. In order to solve the above problem, the present invention provides a shaping device that shapes a shaped object in which at least a part is colored by overlapping layers of ink, the shaping device including: a plurality of head units each of which ejects ink from a plurality of nozzle rows; and a carriage that holds the plurality of head units, in which each of the head units includes the plurality of nozzle rows each of which ejects ink supplied from an ink container via different ink supply paths, and the carriage holds, as the plurality of head units: a first head unit including the plurality of nozzle rows each of which ejects colored ink of different colors; and a second head unit including the plurality of nozzle rows each of which ejects ink different from the colored ink ejected by the first head unit.

With such a configuration, the use of the head units appropriately makes it possible to reduce the size and weight of the carriage. Furthermore, by ejecting colored inks of a plurality of colors in the nozzle row of the first head unit and ejecting other inks in the nozzle row of the second head unit, the difference in the consumption amount between the inks ejected from the same head unit can be appropriately reduced. Thus, the replacement cost of the components in the shaping device can be appropriately prevented from being excessively increased by the replacement of the head unit. According to such configuration, a configuration suitable for the shaping device that shapes the colored shaped object can be appropriately realized.

In this configuration, the shaping device supplies the ink from a plurality of ink containers each storing the ink to the head unit. In this case, each nozzle row in the head unit receives the supply of the ink from one of the ink containers. Furthermore, each head unit can be considered as, for example, a component of a unit of replacement to be collectively replaced at the time of repair or maintenance. In this case, the plurality of nozzle rows in one head unit can be considered to be integrally formed in one component. In each head unit, the plurality of nozzle rows can be considered to be arranged while maintaining a predetermined positional relationship. According to such configuration, the head unit can be appropriately used in the shaping device.

Furthermore, in this configuration, the shaping device shapes the shaped object including a light reflecting region and a coloring region. In this case, the light reflecting region is a region formed using ink of a light reflective color. The coloring region is formed on the outer side of the light reflecting region using the colored inks of the plurality of colors ejected by the first head unit and the clear ink. In this case, each of the plurality of nozzle rows in the first head unit ejects each of colored inks of a plurality of colors used for forming the coloring region. The second head unit includes, as at least a part of the plurality of nozzle rows, a nozzle row that ejects a light reflective ink, a nozzle row that ejects a clear ink, and a nozzle row that ejects an ink to be a material of the support layer. The clear ink can be considered as a colorless and transparent ink or the like. The support layer can be considered as a configuration that supports at least a part of the shaped object at the time of shaping the shaped object.

According to such configuration, the colored shaped object can be appropriately shaped. Furthermore, the difference in the consumption amount can be appropriately reduced for a plurality of types of inks ejected from one head unit by collecting the nozzle row that ejects the colored ink used for forming the coloring region to the first head unit. Furthermore, in this case, the coloring region is preferably a region formed with only the colored ink of a plurality of colors ejected from the first head unit and the clear ink ejected from the second head unit. According to such configuration, for the nozzle row for the colored ink in which the consumption amount at the time of shaping is reduced, all the nozzle rows can be collected in the first head unit. Thus, the difference in the consumption amount can be more appropriately reduced for the plurality of types of inks ejected from one head unit.

Furthermore, in this configuration, the shaping device may further include a main scan drive unit, a flattening means, and the like. The main scan drive unit can be considered as a configuration that causes a plurality of head units to perform a main scanning operation of ejecting ink while moving in a main scanning direction set in advance. The flattening means can be considered as a configuration including a flattening roller that flattens the layer of ink. In this case, the main scan drive unit includes a guide member that guides the movement of the carriage in the main scanning direction, and a drive mechanism that moves the carriage along the guide member. The flattening means is held by the guide member so as to be movable in the main scanning direction outside the carriage. With such a configuration, by providing the flattening means outside the carriage, it is possible to more appropriately reduce the size and weight of the carriage. As the guide member, a guide rail or the like which is a rail-shaped guide member can be suitably used.

Furthermore, when using the shaping device having the above configuration, the feature of the present invention can also be considered as a feature of the maintenance method of the shaping device. In this case, the maintenance method of the shaping device prompts a user to replace each of the head units based on an operating amount at which the shaping device operates, and urges the user to replace each of the head units such that the second head unit is replaced more frequently than the first head unit by setting the first head unit and the second head unit differently from each other in association between the operating amount and a replacement timing. According to such configuration, the second head unit that ejects the ink having a large consumption amount can be appropriately replaced in a shorter cycle than the first head unit. Thus, the maintenance of the shaping device can be more appropriately carried out according to the application of the ink ejected from each head unit, and the like. The features of the present invention can also be considered as the features of the invention of the shaping method of shaping a shaped object with the shaping device having the above configuration. Also in these cases, the same effects as described above can be obtained. Furthermore, in this case, the shaping method can also be considered as a manufacturing method of the shaped object.

### EFFECT OF THE INVENTION

According to the present invention, a configuration suitable for a shaping device that shapes a colored shaped object can be appropriately realized.

### BRIEF DESCRIPTION OF THE DRAWINGS

FIG. 1 is a view describing a shaping device 10 according to one embodiment of the present invention. FIG. 1(a) shows an example of a configuration of a main part of the shaping device 10. FIG. 1(b) shows an example of a configuration of a head part 12 in the shaping device 10.

FIG. 2 is a view illustrating an example of a more specific configuration of the head part 12. FIGS. 2(a) and 2(b) show an example of a specific configuration of the head part 12.

FIG. 3 is a view showing an example of a configuration of a shaped object 50 shaped by the shaping device 10.

FIG. 4 is a view describing a main scan drive unit 18 and a head part 12 in more detail.

### DESCRIPTION OF EMBODIMENTS

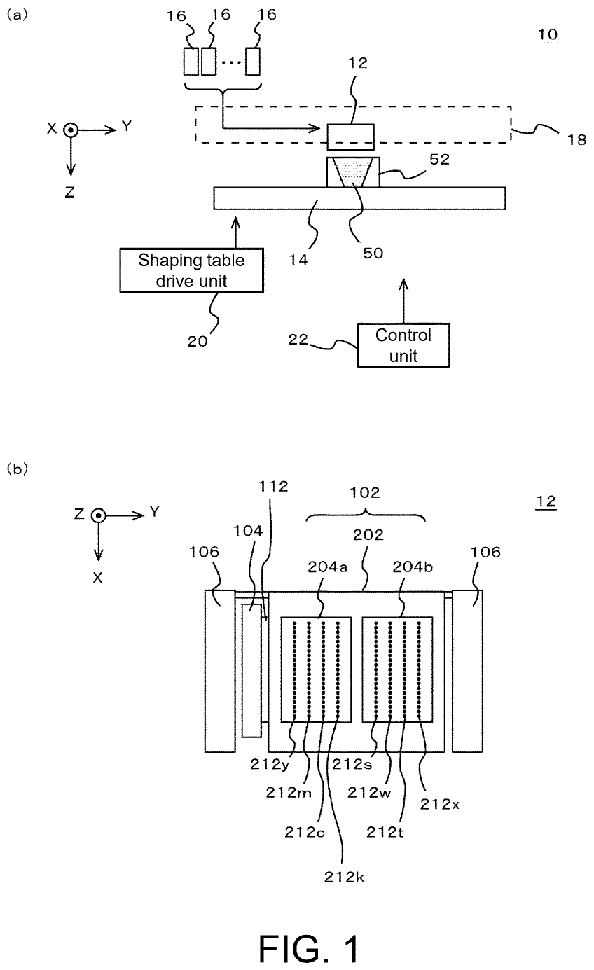

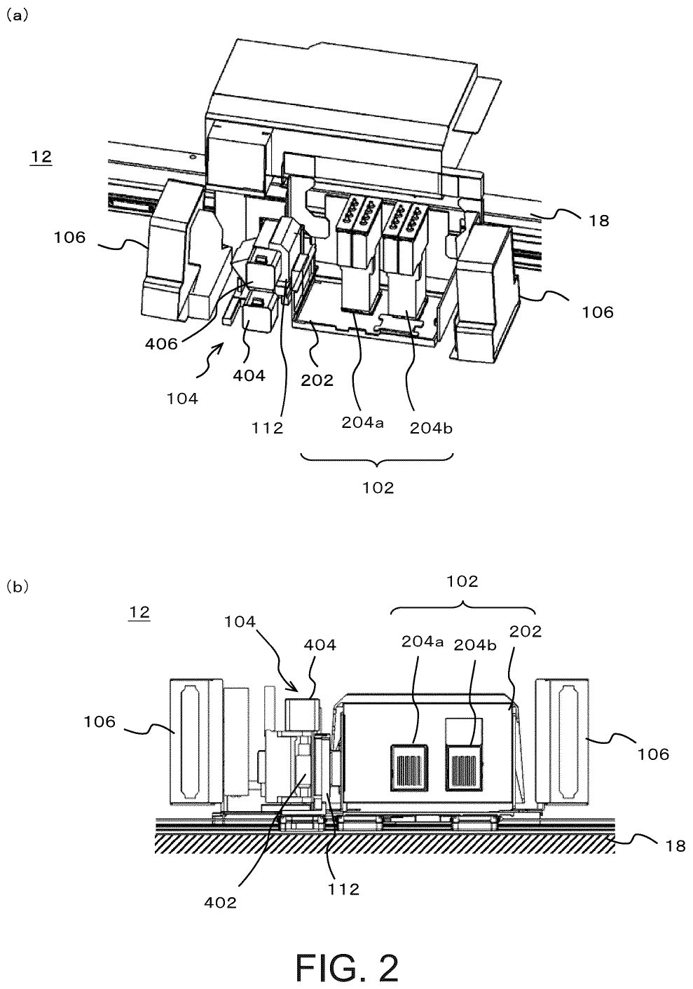

Hereinafter, an embodiment according to the present invention will be described with reference to the drawings. FIGS. 1 and 2 are views describing a shaping device 10 according to one embodiment of the present invention. FIG. 1(a) shows an example of a configuration of a main part of the shaping device 10. FIG. 1(b) shows an example of a configuration of a head part 12 in the shaping device 10. FIG. 2 shows an example of a more specific configuration of the head part 12. FIGS. 2(a) and 2(b) are a partially exploded perspective view and a bottom view showing an example of a specific configuration of the head part 12 together with a part of a main scan drive unit 18 in the shaping device 10.

In the present example, the shaping device 10 is a device (3D printer) that shapes a stereoscopic shaped object by a layered shaping method, and shapes a shaped object 50 in which at least a part is colored by using ink as a material of shaping and forming layers of ink in an overlapping manner. In this case, the shaped object 50 can be considered as a stereoscopic three-dimensional structure or the like. Furthermore, in the present example, the shaping device 10 is a full-color shaping device capable of shaping a shaped object colored in full color, and executes the operation of shaping of the shaped object 50 based on shaped object data that is data indicating the shaped object to shape. In this case, the shaping device 10 receives the shaped object data from, for example, a computer (control PC) that controls the operation of the shaping device 10.

Furthermore, as shown in the drawing, in the present example, the shaping device 10 includes a head part 12, a shaping table 14, a plurality of ink tanks 16, a main scan drive unit 18, a shaping table drive unit 20, and a control unit 22. Except for the points described below, the shaping device 10 may have a configuration same as or similar to a known shaping device. More specifically, other than the points described below, the shaping device 10 may have features same as or similar to a known shaping device that ejects ink to become a material of shaping through an inkjet method to perform shaping. Furthermore, other than the illustrated configuration, the shaping device 10 may further include various configurations necessary for shaping, and the like of the shaped object 50.

The head part 12 is configured to eject the material of the shaped object 50. In the present example, the ink is used as the material of the shaped object 50, as described above. The ink can be considered as a functional liquid or the like. Furthermore, the ink can also be considered as a liquid or the like ejected from the head part 12 by the inkjet method. Furthermore, in the present example, the head part 12 includes an inkjet head that ejects ink through an inkjet method, and ejects an ultraviolet curable ink (UV ink) that cures from a liquid state by irradiation of an ultraviolet ray from the inkjet head. In this case, the ultraviolet curable ink can be considered as an example of an ink that cures according to a predetermined condition. Furthermore, the head part 12 further ejects a support material ink, which is an ink to become the material of a support layer 52, in addition to the ink to become the material of the shaped object 50. Thus, the head part 12 forms the support layer 52 at the periphery of the shaped object 50 and the like as necessary. The support layer 52 can be considered as a layered structure or the like that supports at least a part of the shaped object 50 being shaped. The support layer 52 is formed as necessary at the time of shaping of the shaped object 50, and is removed after the shaping is completed. Furthermore, in the present example, the head part 12 includes a head unit that ejects a plurality of types of inks different from each other as the inkjet head. In this case, the fact that the type of ink is different can also be considered as that the color or use is different. In the following description, for convenience of explanation, the color of the ink may simply be different for different types of ink including different uses of the ink. The specific configuration of the head part 12 and the type of ink used in the head part 12 will be described in more detail later.

The shaping table 14 is a table-shaped member that supports the shaped object 50 being shaped, and is arranged at a position facing the head part 12, and mounts the shaped object 50 being shaped and the support layer 52 on the upper surface. Furthermore, in the present example, the shaping table 14 has a configuration movable in each of a sub scanning direction (X direction in the drawing) and a layering direction (Z direction in the drawing) set in advance in the shaping device 10 by being driven by the shaping table drive unit 20. In this case, the movement in the sub scanning direction or the layering direction can be considered as movement in a direction parallel to the sub scanning direction or the layering direction. The layering direction can be considered as a direction in which the material of shaping is layered in the layered shaping method. Furthermore, in the present example, the layering direction is a direction orthogonal to a main scanning direction (Y direction in the figure) and a sub scanning direction set in advance in the shaping device 10. Each of the plurality of ink tanks 16 is an ink container that stores ink. As the ink tank 16, a known ink bottle or the like can be suitably used. Furthermore, in the present example, the plurality of ink tanks 16 stores the ink of each color ejected from the head part 12, and supplies the ink of each color from the outside of the head part 12 to the head part 12 according to the progress of the shaping operation.

The main scan drive unit 18 is a drive unit that causes the head part 12 to perform a main scanning operation (Y scanning). The main scanning operation can be considered as an operation of ejecting ink while moving in the main scanning direction. In this case, causing the head part 12 to performing the main scanning operation can also be considered as causing the inkjet head (head unit) of the head part 12 to perform the main scanning operation. Furthermore, in the present example, the main scan drive unit 18 causes the head part 12 to perform the main scanning operation by fixing the position of the shaping table 14 and moving the head part 12 in the main scanning direction. A specific configuration of the main scan drive unit 18 will be described in more detail later.

The shaping table drive unit 20 is a drive unit that moves the shaping table 14, and moves the shaping table 14 in each of the sub scanning direction and the layering direction. Furthermore, in the present example, the shaping table drive unit 20 moves the shaping table 14 in the sub scanning direction between the main scanning operations during the formation of one layer of ink. The shaping table drive unit 20 thereby causes the head part 12 to perform a sub scanning operation (X scanning) of relatively moving in the sub scanning direction with respect to the shaped object 50 being shaped. The sub scanning operation can also be considered as an operation of relatively moving with respect to the shaping table 14 in the sub scanning direction by a feeding amount set in advance. Furthermore, after one layer of ink is formed and before the formation of the next layer of ink is started, the shaping table drive unit 20 moves the shaping table 14 in a direction away from the head part 12 in the layering direction. The shaping table drive unit 20 thereby causes the head part 12 to perform a layering direction scanning operation (Z scanning) of relatively moving in the layering direction with respect to the shaped object 50 being shaped. The layering direction scanning operation can also be considered as an operation of adjusting the relative position between the shaped object 50 being shaped and the head part 12 in the layering direction in accordance with the progress of the shaping operation.

The control unit 22 includes a CPU of the shaping device 10, and controls the operation of shaping of the shaped object 50 by controlling each unit of the shaping device 10. In this case, the control unit 22 generates slice data, which is data indicating a cross-section of the shaped object 50 to be shaped, based on the shaped object data. In the operation of forming each layer of ink configuring the shaped object 50, the operation of the head part 12 is controlled based on the slice data to cause the head part 12 to eject the ink of each color used for the shaping of the shaped object 50. According to the present example, the shaping of the shaped object 50 can be appropriately executed.

Next, the configuration and the like of the head part 12 in the shaping device 10 will be described in more detail. In the present example, the head part 12 includes an ink ejection unit 102, a flattening roller unit 104, and a plurality of light source units 106. The ink ejection unit 102 is a part that ejects ink in the head part 12, and includes a carriage 202 and a plurality of head units 204a and 204b.

The carriage 202 is a holding member that holds the plurality of head units 204a and 204b, and holds each of the plurality of head units 204a and 204b so that the ejecting direction of the ink is a direction toward the shaping table 14. As will be described in detail below, in the head part 12 of the present example, the flattening roller unit 104 and the light source unit 106 are disposed outside the carriage 202. Therefore, it can be considered that the carriage 202 holds the plurality of head units 204a and 204b and does not hold each configuration of the flattening roller unit 104 (for example, a flattening roller or the like) and each configuration of the light source unit 106. Furthermore, in this case, the flattening roller unit 104 and the light source unit 106 can be considered as being configured as a unit different from each configuration of the ink ejection unit 102. Furthermore, in the present example, the carriage 202 holds the plurality of head units 204a and 204b in an exchangeable (detachable) manner in a carriage base, which is a member configuring a base portion of the carriage 202 on a side facing the shaping table 14. The carriage 202 holds the plurality of head units 204a and 204b aligned in the main scanning direction with their positions in the sub scanning direction aligned. In this case, it can be considered that the head units 204a and 204b are arranged in an in-line arrangement such that the regions to eject the ink in each main scanning operation are the same.

The plurality of head units 204a and 204b are an example of an ejection head that ejects a material of shaping. In the present example, each of the plurality of head units 204a and 204b is an inkjet head that ejects inks of a plurality of colors different from each other, and includes a plurality of nozzle rows 212 that each ejects ink supplied from any one of the ink tanks 16 via supply paths of different inks. In this case, the difference in the ink supply path can also be considered that the supply paths for supplying the ink from the ink tank 16 to the head part 12 are independent from each other. Furthermore, in the present example, the fact that the supply paths of the ink to the respective nozzle rows 212 are different can also be considered as that the respective nozzle rows 212 receive the supply of the ink from the ink tanks 16 different from each other. Furthermore, the nozzle row 212 can be considered as a row of nozzles arranged with their positions shifted in the predetermined nozzle row direction. Furthermore, in the present example, the plurality of nozzle rows 212 in each of the head units 204a and 204b are arranged in the main scanning direction with the positions in the sub scanning direction aligned with a direction parallel to the sub scanning direction as the nozzle row direction.

In the present example, each of the head units 204a and 204b is a four-color head unit having the nozzle rows 212 for four colors. The head unit 204a is an example of a first head unit, and includes a plurality of nozzle rows 212y to 212k that respectively eject color inks of different colors as distinguished as nozzle rows 212y, 212m, 212c, and 212k in the figure. The color ink of each color ejected from the plurality of nozzle rows 212y to 212k of the head unit 204a is an ink for coloring used at the time of forming the coloring region in the shaped object 50. In the present example, the color ink of each color is an example of a colored ink. Furthermore, each of the plurality of nozzle rows 212y to 212k of the head unit 204a can be considered to eject each of the color inks of a plurality of colors used for forming the coloring region. Furthermore, in the present example, the nozzle row 212y is a nozzle row that ejects ink of yellow color (Y color). The nozzle row 212m is a nozzle row that ejects magenta (M color) ink. The nozzle row 212c is a nozzle row that ejects cyan (C color) ink. The nozzle row 212k is a nozzle row that ejects ink of black color (K color). Each color of YMCK is an example of a basic color (process color) of color representation in the subtractive color mixing method.

Furthermore, the head unit 204b is an example of a second head unit, and includes a plurality of nozzle rows 212s to 212x, each of which ejects ink of a color different from the color ink ejected from the head unit 204a, as distinguished and shown as nozzle rows 212s, 212w, 212t, and 212x in the drawing. In this case, the nozzle row 212s is a nozzle row that ejects the support material ink. The nozzle row 212w is a nozzle row that ejects white ink. In the present example, the white ink is an example of a light reflective ink, and is used when forming the light reflecting region of the shaped object 50. The nozzle row 212t is a nozzle row that ejects the clear ink. The clear ink can be considered as a colorless and transparent ink. The clear ink can be considered as an uncolored translucent ink, an ink to which a coloring material is not intentionally added, or the like. Furthermore, in the present example, the clear ink is used at the time of forming the coloring region of the shaped object 50 together with the ink of each color of YMCK.

Furthermore, in the head unit 204b, the nozzle row 212x is a nozzle row for ejecting ink of various colors or uses as necessary. It is conceivable to use the nozzle row 212x as a second nozzle row for ink in which the consumption amount is particularly large at the time of shaping. In this case, for example, consideration is made to ejecting the support material ink, white ink, and the like in the nozzle row 212x. Furthermore, it is also conceivable to use the nozzle row 212x as a spare nozzle row. In this case, it is conceivable to use the nozzle row 212x instead of when any one of the nozzle rows 212 of the head units 204a and 204b fails. Furthermore, consideration is made to using the nozzle row 212x to eject the ink of a special color other than the ink of each color described above.

In the head part 12, the flattening roller unit 104 is an example of a flattening means. In the present example, as shown in FIGS. 2(a) and 2(b), the flattening roller unit 104 includes a flattening roller 402 and a plurality of motors 404 and 406, and is arranged at a position adjacent to the carriage 202 outside the carriage 202 of the ink ejection unit 102 of the head part 12. The flattening roller 402 is a roller that flattens the layer of ink, and flattens the layer of ink by coming into contact with the surface of the layer of ink and removing a part of the ink before curing at the time of the main scanning operation. Furthermore, in the present example, the flattening roller 402 flattens the layer of ink by coming into contact with the uncured ink while rotating in a predetermined direction at the time of the main scanning operation, and scraping the ink at a position higher than a predetermined height. The motor 404 is an example of a rotation motor, and generates a driving force for rotating the flattening roller 402. The motor 406 is an example of a roller moving motor, and generates a driving force for moving the flattening roller 402 in the vertical direction. In the present example, the motor 406 moves the flattening roller 402 up and down in the vertical direction by supplying power to a mechanism unit that moves the flattening roller 402 in the vertical direction.

Furthermore, in the present example, the flattening roller unit 104 is connected to the carriage 202 of the ink ejection unit 102 by a connecting unit 112 on one side of the ink ejection unit 102 in the main scanning direction. In this case, the connection of the flattening roller unit 104 with the carriage 202 can also be considered that the carriage 202 and the flattening roller unit 104 are joined so that the flattening roller unit 104 moves according to the carriage 202 when the head part 12 moves during the main scanning operation. According to such configuration, the operation of flattening by the flattening roller 402 can be appropriately executed while arranging the flattening roller 402 outside the carriage 202. Thus, the shaping of the shaped object 50 can be appropriately carried out with high accuracy.

Furthermore, in the present example, the connecting unit 112 connects the flattening roller unit 104 and the carriage 202 by the attraction force of the magnet. With this configuration, the relative positions of the flattening roller unit 104 and the carriage 202 can be easily changed, and the state in which the flattening roller unit 104 moves together with the carriage 202 during the main scanning operation can be appropriately realized. In this case, it can also be considered that the positional relationship between the flattening roller unit 104 and the carriage 202 is not completely fixed, but the relative position is easily adjusted. In addition, such a connection manner can also be considered as a state in which both are connected with a certain degree of looseness. In addition, the connection realized by the attraction force of the magnet as in the present example can be considered as an example of joining that can be easily separated, and the positional relationship can be easily changed and adjusted. In this case, the position (joining position) where the flattening roller unit 104 is attached to the carriage 202 can also be easily and appropriately adjusted.

The connection between the flattening roller unit 104 and the carriage 202 by the attraction force of the magnet is not necessarily directly applied to the flattening roller unit 104 and the carriage 202, but may be realized by applying the attraction force of the magnet to the member fixed to each of the flattening roller unit 104 and the carriage 202. Furthermore, in the present example, the connecting unit 112 is a part of the flattening roller unit 104, and the position thereof is fixed with respect to the flattening roller 402. The connecting unit 112 includes a magnet, and joins the flattening roller unit 104 and the carriage 202 by being attracted to any position of the ink ejection unit 102 by the attraction force of the magnet. Furthermore, consideration is made to arranging the magnet on the ink ejection unit 102 side instead of the connecting unit 112 in the flattening roller unit 104. In this case, the connecting unit 112 is connected to the carriage 202 by the attraction force of the magnet on the ink ejection unit 102 side by having a metal member and the like attracted by the magnet. Furthermore, in a modification of the head part 12, the connecting unit 112 may have a configuration different from the flattening roller unit 104. In this case, the connecting unit 112 is attracted to any position of the flattening roller unit 104 by the attraction force of the magnet. Furthermore, the connecting unit 112 may be a part of the ink ejection unit 102. Furthermore, in a further modification of the head part 12, the connecting unit 112 may connect the flattening roller unit 104 and the carriage 202 by a method other than the attraction force of the magnet. The manner of connecting the flattening roller unit 104 and the carriage 202 and the like will be described in more detail later.

The plurality of light source units 106 are unit components having a light source (UV light source) for curing the ink, and generate an ultraviolet ray for curing the ultraviolet curable ink. In the present example, each of the plurality of light source units 106 is arranged on one end side and the other end side in the main scanning direction in the head part 12 so as to sandwich the ink ejection unit 102 and the flattening roller unit 104 therebetween. A UVLED (ultraviolet LED) or the like can be suitably used as the light source in the light source unit 106. Furthermore, it is also conceivable to use a metal halide lamp, a mercury lamp, or the like as the light source in the light source unit 106. Furthermore, in the present example, the plurality of light source units 106 are also arranged outside the carriage 202 of the ink ejection unit 102, and is connected to the carriage 202 so that the plurality of light source units 106 moves along the carriage 202 at the time of the main scanning operation. In this case, it is conceivable to couple the light source unit 106 to the carriage 202 with a configuration different from the connecting of the flattening roller unit 104 to the carriage 202. It is conceivable that each of the plurality of light source units 106 is connected so that the positional relationship therebetween is fixed using, for example, a member fixed with respect to a predetermined position in each of the ink ejection unit 102 and the plurality of light source units 106. According to such configuration, the light source unit 106 having a larger weight than the flattening roller unit 104 can be appropriately joined to the ink ejection unit 102. In this case, the connection between the light source unit 106 and the carriage 202 can be considered to be stronger than the connection between the flattening roller unit 104 and the carriage 202. Furthermore, in the modification of the head part 12, the connection between the light source unit 106 and the carriage 202 may also be performed by the attraction force of the magnet, similarly to the connection between the flattening roller unit 104 and the carriage 202.

By using the head part 12 having the above configuration, the layer of ink configuring the shaped object 50 can be appropriately formed. Furthermore, the shaped object 50 can be appropriately shaped by forming a plurality of ink layers in an overlapping manner. Furthermore, in the head part 12 of the present example, the miniaturization and weight reduction of the carriage 202 can be realized by the above configuration. In this case, the weight reduction of the carriage 202 can be considered as the weight reduction of the total weight of the configuration held by the carriage 202, and the like. As described above, in the present example, each of the head units 204a and 204b ejects inks of a plurality of colors. In this case, the size and weight of the configuration for ejecting the inks of a plurality of colors of the same number of colors are reduced as compared with the case of using a plurality of inkjet heads for single color that ejects only the ink of one color. Therefore, in the head part 12, by ejecting the inks of a plurality of colors using the head units 204a and 204b, the miniaturization and weight reduction of the carriage 202 can be appropriately realized. Further, in the present example, by arranging the flattening roller unit 104 outside the carriage 202, further miniaturization and weight reduction of the carriage 202 can be realized.

Here, in the present example, the plurality of head units 204a and 204b are detachably attached to the carriage base of the carriage 202 by a predetermined attachment mechanism (attachment means). Furthermore, each of the head units 204a and 204b in the present example can be considered as an inkjet head having a plurality of functions of inkjet heads for single color that respectively eject inks of different colors or uses. Furthermore, the head units such as the head units 204a and 204b are integrated in units, and can be considered as components or the like that are collectively replaced at the time of repair or maintenance. Furthermore, the head unit can also be considered as a component or the like of a unit of replacement to be collectively replaced when any nozzle row in the head unit fails. The failure of the nozzle row can be considered as a failure or the like that requires replacement. Furthermore, the component of the unit of replacement can be considered as a component or the like to be replaced in the replacement work performed in the normal maintenance work of the shaping device 10. The normal maintenance work can be considered as a maintenance work or the like performed by a method described in a maintenance manual or the like. In this case, the head unit can also be considered as a configuration in which the head unit is not disassembled into the nozzle row for each color in the maintenance work.

The head units used as the head units 204a and 204b can also be considered as components of a unit of sale sold as inkjet heads for a plurality of colors. The plurality of nozzle rows in one head unit can be considered to be integrally formed in one component. In this case, the fact that the plurality of nozzle rows are integrally formed in one component of the head unit can also be considered as that the plurality of nozzle rows are formed at predetermined positions in the fixed-shape housing constituting the outer surface shape of the head unit. In each head unit, the plurality of nozzle rows can be considered to be arranged while maintaining a predetermined positional relationship. Furthermore, in the head unit, the position of each nozzle row may be adjustable (fine adjustment) within a predetermined adjustable range. In this case, arranging the plurality of nozzle rows while maintaining the predetermined positional relationship can also be considered as maintaining the predetermined positional relationship in the adjustable range corresponding to each nozzle row. The arrangement of the plurality of nozzle rows while maintaining the predetermined positional relationship can also be considered as that the positional relationship of the adjustment reference position in each nozzle row is determined. Each head unit has a nozzle plate that is a plate-like body in which through holes serving as nozzles in the nozzle row are formed side by side. In this case, a nozzle plate or the like in which nozzle rows for a plurality of colors are formed can be suitably used. Each of head units 204a and 204b may have a plurality of nozzle plates. As each of the plurality of nozzle plates, a nozzle plate having a plurality of nozzle rows may be used. In this case, it is possible to consider a configuration in which each of the head units 204a and 204b has two nozzle plates, and nozzle rows for two colors are formed in each nozzle plate (one nozzle plate).

Considering the head unit in a more generalized manner, it is also conceivable to use a configuration in which a plurality of inkjet heads for single color is combined as the head unit. In this case as well, by using a configuration in which a plurality of inkjet heads for single color are compactly combined as a unit of replacement, it is possible to reduce the size and weight of the carriage as compared with the case of individually attaching each inkjet head for single color to the carriage. Furthermore, in this case, fine adjustment of the positional relationship in the head unit may be enabled for each inkjet head for single color collected in the head unit.

As described above, the carriage 202 of the ink ejection unit 102 of the present example is configured to hold the plurality of head units 204a and 204b. On the other hand, in the flattening roller unit 104, it is conceivable to separately use a holding member for holding the flattening roller 402. In this case, the holding member of the flattening roller unit 104 can also be considered as a carriage or the like of the flattening roller unit 104. In this case, the configuration of the flattening roller unit 104 can be considered as holding the flattening roller 402 by a carriage separate from the carriage 202 of the ink ejection unit 102. The carriage 202 of the ink ejection unit 102 may hold the head units 204a and 204b without holding the flattening roller 402. In this case, the connecting unit 112 can be considered as a configuration of connecting the carriage for the flattening roller 402 of the flattening roller unit 104 to the carriage 202 of the ink ejection unit 102, and the like.

Furthermore, in the head part 12 of the present example, the type of ink ejected by each of the head units 204a and 204b is determined according to the application of ink instead of simply using the head units 204a and a and 204b. As described above, in the present example, the ink of each color of YMCK used for forming the coloring region of the shaped object 50 is ejected by the nozzle row of a plurality of colors of the head unit 204a. Then, other inks are ejected by the plurality of nozzle rows of the head unit 204b. Thus, the ink of each color of YMCK, which consumption amount is reduced at the time of shaping of the shaped object 50, is ejected only from the head unit 204a. According to such configuration, the difference in the consumption amount between the inks ejected from the same head unit can be appropriately reduced. Thus, the replacement cost of the components of the shaping device 10 can be appropriately prevented from being excessively increased by the replacement of the head unit. Furthermore, in the following, this point will be described in more detail in association with the configuration of the shaped object 50 shaped by the shaping device 10.

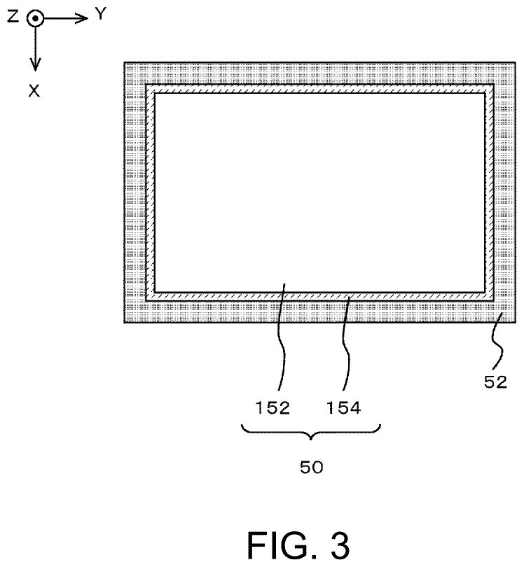

FIG. 3 is a view showing an example of a configuration of the shaped object 50 shaped by the shaping device 10 (see FIG. 1), and shows an example of a configuration of an X-Y cross section, which is a cross section of the shaped object 50 orthogonal to the layering direction (Z direction). In this case, the configurations of the Z-X cross section and the Z-Y cross section of the shaped object 50 perpendicular to the Y direction and the Z direction have similar configurations. As described above, in the present example, the shaping device 10 shapes the shaped object 50 in which the surface is colored using the color ink (ink of each color of YMCK) ejected from the head unit 204a (see FIG. 1) of the ink ejection unit 102 of the head part 12. In this case, coloring the surface of the shaped object 50 can also be considered as coloring at least a part of a region where hue can be visually recognized from the outside in the shaped object 50. Furthermore, in the present example, the shaping device 10 shapes the shaped object 50 including a light reflecting region 152 and a coloring region 154. Furthermore, the support layer 52 is formed at the periphery of the shaped object 50 and the like as necessary.

The light reflecting region 152 is a region having light reflectivity for reflecting light entering from the outer side of the shaped object 50 through the coloring region 154 and the like. The coloring region 154 can also be considered as, for example, a region that reflects light entering from the outside of the shaped object 50 when carrying out coloring in full color representation with respect to the surface of the shaped object 50. The full color representation can be considered as, for example, a representation of color performed by a possible combination of subtractive color mixing methods with process color inks. Furthermore, in the present example, the shaping device 10 forms the light reflecting region 152 also serving as the interior region of the shaped object 50 using the white ink ejected from the head unit 204b (see FIG. 1) of the ink ejection unit 102. In this case, the interior region can be considered as, for example, a region configuring the interior of the shaped object 50. In this case, the white ink used for forming the light reflecting region 152 can be considered as an example of the shaping ink used for forming the interior region. In a modification of the shaped object 50, the interior region may be formed as a region different from the light reflecting region 152. In this case, the shaping device 10 forms the interior region using an arbitrary ink other than the support material ink. In addition, the light reflecting region 152 is formed around the inner region.

The coloring region 154 is a region colored by the ink of each color of YMCK ejected from the head unit 204a. In the present example, the shaping device 10 forms the coloring region 154 at the periphery (outer side) of the light reflecting region 152 using the ink of each color of YMCK ejected from the head unit 204a and the clear ink ejected from the head unit 204b. Furthermore, in this case, in the shaping device 10, various colors are represented by adjusting the ejection amount of the color ink of each color to each position. The clear ink is used to compensate for the change in the total amount of the color ink caused by the difference in color. According to such configuration, each position of the coloring region 154 can be appropriately colored with a desired color. Thus, the colored shaped object 50 can be appropriately shaped.

Here, in the present example, the coloring region 154 is formed only with the color inks of a plurality of colors (ink of each color of YMCK) ejected from the head unit 204a and the clear ink ejected from the head unit 204b. Furthermore, as in the present example, when forming the coloring region 154 on the surface of the shaped object 50, the consumption amount of the color ink of a plurality of colors used for forming the coloring region 154 is remarkably smaller than the consumption amount of the white ink used for forming the light reflecting region 152 configuring the interior of the shaped object 50, the support material ink used for forming the support layer 52, and the like. As a result, focusing on the number of shots of ejecting the ink from each nozzle row of the head units 204a and 204b at the time of shaping, the number of shots of the white ink and the support material ink becomes remarkably larger than the number of shots of the color ink.

In addition, in the head units 204a and 204b, normally, when the number of shots from any nozzle row increases, a failure easily occurs. As described above, the head units 204a and 204b are usually replaced in units of head units. Therefore, replacement timing of the head units 204a and 204b is usually determined according to the number of shots in the nozzle row having the largest number of shots. In this case, if nozzle rows having greatly different consumption amounts are mixed in one head unit (any one of head units 204a and 204b), the time for replacement arrives early due to the influence of some nozzle rows, and thus the frequency of replacement of the head unit increases, leading to an increase in the operation cost of the shaping device 10. When the nozzle row for the color ink of any color is provided in both the head units 204a and 204b, and further, the nozzle row for the color ink and the nozzle row for the white ink or the support material ink are present in one head unit, it is conceivable that the frequency of replacement becomes high for both the head units 204a and 204b. Furthermore, as a result, it is conceivable that the frequency of replacement of the head unit increases in the shaping device 10.

On the other hand, in the present example, the nozzle row for color ink having a small consumption amount is collected in the head unit 204a, and the nozzle rows for other inks are collected in the head unit 204b. The head unit 204a ejects only the color ink. According to such configuration, the nozzle row of the white ink and the support material ink, which are inks of which consumption amount is particularly large, and the nozzle row for the color ink can be arranged in different head units. Therefore, according to the present example, the difference in the consumption amount can be appropriately reduced for the inks of a plurality of colors ejected from each of the head units 204a and 204b. The head units 204a and 204b can thus be replaced more efficiently and appropriately.

As described above, in the present example, among the inks used for forming the coloring region 154, the clear ink is ejected from the head unit 204b. However, also in this case, the difference in the consumption amount of ink in the head unit 204a can be appropriately reduced by collecting the nozzle row for color ink, which consumption amount is particularly small, in the head unit 204a. The clear ink is likely to consume more than the color ink. Therefore, the head unit 204b that ejects the white ink or the support material ink can also be considered to have a smaller difference in the amount of ink consumed than when providing the nozzle row for any of the color inks.

Furthermore, in the present example, it is conceivable that the head unit 204b that ejects ink having a large consumption amount reaches the end of life earlier than the head unit 204a. Therefore, as a maintenance method of the shaping device 10, a replacement cycle of the head unit 204b is preferably shorter than that of the head unit 204a. Furthermore, in this case, it is conceivable to encourage the user to replace the head units 204a and 204b based on the operating amount in which the shaping device 10 is operated before the failure actually occurs in the head units 204a and 204b. In this case, for example, it is conceivable to associate the operating amount of the shaping device 10 and the replacement timing of the head units 204a and 204b in advance. Furthermore, in this case, by making the association between the operating amount and the replacement timing different between the head unit 204a and the head unit 204b, the user is urged to replace each of the head units 204a and 204b so that the head unit 204b is replaced more frequently than the head unit 204a. According to such configuration, the head unit 204b that ejects ink having a large consumption amount can be appropriately replaced in a shorter cycle than the head unit 204a. Thus, the maintenance of the shaping device 10 can be more appropriately carried out according to the application of the ink ejected from each of the head units 204a and 204b, and the like.

Furthermore, in this case, the shaping device 10 further includes, for example, a storage unit that stores association information in which the operating amount and the replacement timing are associated, a display unit for urging the user to replace the head units 204a and 204b, and the like. Then, the control unit 22 (see FIG. 1) of the shaping device 10 displays a message or the like prompting the user to replace the head units 204a and 204b on the display unit based on the association information and the operating amount of the shaping device 10. Furthermore, as the operating amount of the shaping device 10, for example, it is conceivable to manage the operating time and the like during which the shaping device 10 executes the shaping operation. As the operating amount of the shaping device 10, it is also conceivable to manage the elapsed time (for example, elapsed days, and the like) from the replacement of each of the head units 204a and 204b. Furthermore, it is also conceivable to manage the amount of ink ejected from each nozzle row of the head units 204a and 204b as the operating amount of the shaping device 10.

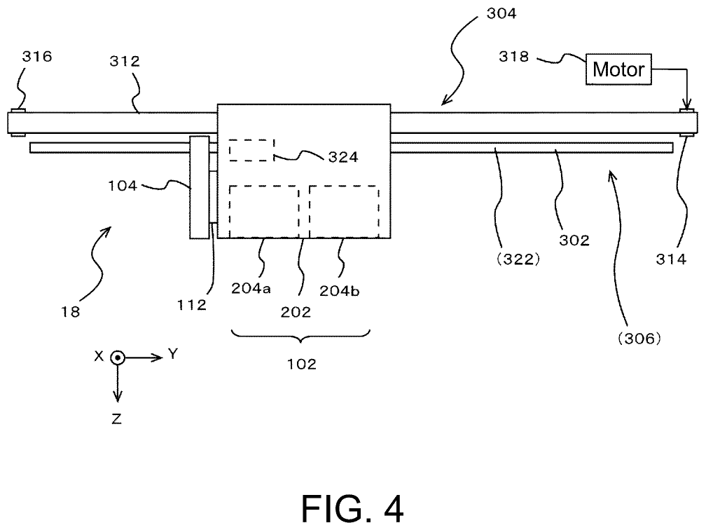

Next, features of the main scan drive unit 18 (see FIG. 1) and the flattening roller unit 104 (see FIG. 1) of the head part 12 of the present example will be described in more detail. FIG. 4 is a view describing the main scan drive unit 18 and the head part 12 in more detail, and shows an example of a specific configuration of the main scan drive unit 18 together with a part of the head part 12. Furthermore, in FIG. 4, for convenience of illustration, the light source unit 106 (see FIG. 1) of the head part 12 is omitted, and the ink ejection unit 102 and the flattening roller unit 104 are illustrated.

As described above, the head part 12 of the present example includes the flattening roller unit 104 and the light source unit 106 outside the carriage 202 in the ink ejection unit 102. In this case, the main scan drive unit 18 causes the head part 12 to perform the main scanning operation while holding the flattening roller unit 104 and the light source unit 106 outside the carriage 202 in the head part 12. Furthermore, in the present example, the main scan drive unit 18 includes a guide rail 302, a drive mechanism 304, and a linear encoder 306. The guide rail 302 is an example of a guide member that guides the movement of the carriage 202 of the ink ejection unit 102 in the main scanning direction. Furthermore, in the present example, the guide rail 302 is a rail-shaped member extending in the main scanning direction, and holds the carriage 202 so that the carriage 202 is movable along the rail. In this case, the guide rail 302 allows the carriage 202 to move along the guide rail 302 by engaging the carriage 202 itself or a member fixed in position with respect to the carriage 202 with the guide rail 302.

As the guide rail 302, for example, it is conceivable to use a configuration including a rail portion and a moving portion. In this case, the rail portion is a rail-shaped portion of the guide rail 302. The moving portion is configured to move along the rail portion. When the guide rail 302 having such a configuration is used, the guide rail 302 movably holds the carriage by fixing the carriage 202 to the moving portion. The carriage 202 is moved in the main scanning direction by moving the moving portion along the rail portion. As such a guide rail 302, a known LM guide (registered trademark) or the like can be suitably used. The LM guide can be considered as a member or the like that guides the linear motion portion of the machine by the rolling operation.

In the present example, the guide rail 302 holds the flattening roller unit 104 so as to be movable in the main scanning direction independently of the ink ejection unit 102. When the guide rail 302 having the rail portion and the moving portion is used, holding the flattening roller unit 104 independently of the ink ejection unit 102 by the guide rail 302 can also be considered as fixing the flattening roller unit 104 to the moving portion of the guide rail 302 separately from the ink ejection unit 102. In this case, it is conceivable to fix the flattening roller unit 104 to the moving portion at a position different from the fixing position of the ink ejection unit 102. Furthermore, as described above, the holding member for holding the flattening roller 402 of the flattening roller unit 104 can be considered as the carriage of the flattening roller unit 104, and the like separate from the carriage 202 of the ink ejection unit 102. In this case, holding the flattening roller unit 104 independently of the ink ejection unit 102 by the guide rail 302 can also be considered as holding the carriage of the flattening roller unit 104 and the carriage 202 of the ink ejection unit 102 by the guide rail 302.

Although not illustrated, the guide rail 302 holds the light source unit 106 so as to be movable in the main scanning direction independently of the ink ejection unit 102 and the flattening roller unit 104. In this case, the guide rail 302 movably holding each of the flattening roller unit 104 and the light source unit 106 can also be considered as making each of the flattening roller unit 104 and the light source unit 106 movable along the guide rail 302 by engaging a part of each of the flattening roller unit 104 and the light source unit 106 with the guide rail 302. It can be considered that the guide rail 302 holds the flattening roller unit 104 and the light source unit 106 so as to be movable in the main scanning direction outside the carriage 202 of the ink ejection unit 102.

When configured in such manner, the weight of each configuration of the head part 12 can be dispersed and supported at a plurality of positions of the guide rail 302. Thus, according to such configuration, the weight can be appropriately prevented from concentrating on the position where the guide rail 302 holds the carriage 202 as compared with the case where the flattening roller and the like are also held by the carriage 202 of the ink ejection unit 102. Accordingly, it is possible to appropriately prevent the guide rail 302 from being bent. Furthermore, as can be understood from the configuration and the like illustrated in FIG. 2(b), in the present example, the guide rail 302 supports the carriage 202 in the cantilever state by supporting the carriage 202 from one side in the sub scanning direction. In this case, when the weight of the carriage 202 increases, the side of the carriage 202 opposite to the guide rail 302 bends downward, so that a so-called bowing state is likely to occur. On the other hand, in the present example, such a problem can be appropriately prevented by arranging the flattening roller unit 104 outside the carriage 202.

Here, as described above, it is conceivable to use a configuration including a rail portion and a moving portion as the guide rail 302. In this case, in the guide rail 302, it is conceivable to hold the flattening roller unit 104 and the light source unit 106 by attaching the flattening roller unit 104 and the light source unit 106 to the moving portion. Furthermore, in this case, it is conceivable to attach the ink ejection unit 102, the flattening roller unit 104, and the plurality of light source units 106 to one moving portion. According to such configuration, the flattening roller unit 104 and the light source unit 106 can be appropriately moved together with the carriage 202 of the ink ejection unit 102. Furthermore, in this case, the flattening roller unit 104 can be more appropriately moved by connecting the carriage 202 and the flattening roller unit 104 by the connecting unit 112. The guide rail 302 may have a plurality of moving portions that move along one rail portion. In this case, each of the flattening roller unit 104 and the light source unit 106 may be fixed to a moving portion different from the moving portion to which the ink ejection unit 102 is fixed. With this configuration, it is possible to more appropriately prevent the weight from concentrating on the position where the guide rail 302 holds the carriage 202.

As described above, in the present example, the flattening roller unit 104 is arranged only on one side in the main scanning direction with respect to the ink ejection unit 102. In this regard, when considering holding the flattening roller by the carriage 202 of the ink ejection unit 102, if the flattening roller is arranged only on one side in the main scanning direction of the carriage 202, a difference in weight may occur between one side and the other side in the main scanning direction. In this case, if the size and weight of the carriage 202 are reduced by using the head units 204a and 204b, for example, the inclination of the carriage 202 such that the side on which the flattening roller is installed in the carriage 202 is lowered is likely to occur due to the weight of the flattening roller. On the other hand, according to the present example, by arranging the flattening roller unit 104 outside the carriage 202, even when the flattening roller is arranged only on one side of the carriage 202, the occurrence of the inclination of the carriage 202 due to the weight of the flattening roller can be more appropriately prevented.

Furthermore, at the time of the main scanning operation, the head part 12 may be reciprocated in the main scanning direction, and the ink may be ejected from the ink ejection unit 102 in both the forward path and the backward path. When the flattening roller unit 104 is disposed only on one side of the ink ejection unit 102 in the main scanning direction as in the present example, it is conceivable to bring the flattening roller 104 into contact with the layer of ink only at the time of movement of the head part 12 in the direction in which the flattening roller 402 is behind the ink ejection unit 102. Thus, in the present example, the flattening roller unit 104 moves the flattening roller 402 in the vertical direction by the driving force of the motor 406, and at the time of the main scanning operation in which the head part 12 moves in the direction in which the flattening roller unit 104 is behind the ink ejection unit 102, the position of the flattening roller 402 is lowered and the layer of ink and the flattening roller 402 are brought into contact with each other. Furthermore, at the time of the main scanning operation in which the head part 12 moves in a direction in which the flattening roller unit 104 is on the front side of the ink ejection unit 102, the flattening roller 402 is retracted upward, and the layer of ink and the flattening roller 402 are not brought into contact with each other. According to the present example, the position of the flattening roller 402 in the vertical direction can be easily and appropriately changed. Thus, when forming the layer of ink by the reciprocating main scanning operation, the flattening of the layer of ink can be more appropriately carried out.

When the flattening roller unit 104 includes the plurality of motors 404 and 406 as in the present example, it is conceivable that the weight of the flattening roller unit 104 becomes heavy. In this case, when the configuration corresponding to the flattening roller unit 104 is held by the carriage 202 of the ink ejection unit 102, the problem of the weight increase of the carriage 202 is considered to be particularly remarkable. Therefore, in the present example, it can be considered that the effect obtained by arranging the flattening roller unit 104 outside the carriage 202 is particularly large.

The drive mechanism 304 is a drive mechanism that moves the carriage 202 of the ink ejection unit 102 along the guide rail 302. In the present example, the drive mechanism 304 includes a belt 312, a driving pulley 314, a driven pulley 316, and a motor 318. The belt 312 is an annular belt member stretched along a moving range of the carriage 202 in the main scanning direction, and rotationally moves along a rotation path having the driving pulley 314 and the driven pulley 316 as ends on one side and the other side in the main scanning direction. Further, the belt 312 moves the carriage 202 in the main scanning direction by rotationally moving in a state where a portion of the carriage 202 or the ink ejection unit 102 whose position is fixed with respect to the carriage 202 is attached to a predetermined position. In this case, the belt 312 appropriately reverses the direction of rotation to reciprocate the carriage 202 in the moving range of the carriage 202 in the main scanning direction.

The driving pulley 314 and the driven pulley 316 are pulleys for stretching and rotating the belt 312. The driving pulley 314 is a pulley that rotates in accordance with power received from the motor 318, and meshes with the belt 312 on one side in the main scanning direction to apply power for rotational movement of the belt 312 to the belt 312. The driven pulley 316 is a pulley that meshes with the belt 312 on the other side in the main scanning direction, and rotates according to the rotational movement of the belt 312. The motor 318 is a motor that rotates the driving pulley 314, and rotates the driving pulley 314 in accordance with an instruction from the control unit 22 (see FIG. 1) of the shaping device 10. According to such configuration, the carriage 202 can be appropriately moved at the time of the main scanning operation. Thus, the head units 204a and 204b, and the like held by the carriage 202 can be appropriately moved in the main scanning direction.

Here, in the present example, the belt 312 is not directly connected to the flattening roller unit 104. Although not illustrated, the belt 312 is not directly connected to the light source unit 106. Therefore, at the time of the main scanning operation, the drive mechanism 304 moves the flattening roller unit 104 and the light source unit 106 according to the movement of the ink ejection unit 102 by moving the ink ejection unit 102. As described above, in the present example, the flattening roller unit 104 and the light source unit 106 are connected to the carriage 202 of the ink ejection unit 102 by the connecting unit 112 and the like. In this case, when the belt 312 moves the carriage 202 in the main scanning direction, the flattening roller unit 104 and the light source unit 106 also move in the main scanning direction according to the movement of the carriage 202. Therefore, according to the present example, each configuration of the head part 12 can be appropriately moved in the main scanning direction at the time of the main scanning operation.

As described above, in the present example, the motor 318 rotates the driving pulley 314 in accordance with an instruction from the control unit 22. In this case, the control unit 22 controls the rotation of the driving pulley 314 by controlling the operation of the motor 318 according to the output of the linear encoder 306. Furthermore, in the present example, the linear encoder 306 includes a linear scale 322 and a sensor 324. The linear scale 322 is a member indicating a scale as a reference of a position, and is arranged to extend in the main scanning direction along the guide rail 302. In the present example, the linear scale 322 indicates each position of the guide rail 302 by being attached to the guide rail 302. The sensor 324 is an optical sensor that reads the scale of the linear scale 322, and is arranged at a predetermined position where the position with respect to the carriage 202 is fixed in the ink ejection unit 102. With this configuration, the position of the carriage 202 can be appropriately detected with high accuracy by reading the scale of the linear scale 322 by the sensor 324. The control unit 22 controls the operation of the motor 318 based on the detection result of the sensor 324, so that the carriage 202 can be moved while the position of the carriage 202 is detected. Therefore, according to the present example, the movement of the carriage 202 can be appropriately controlled with high accuracy at the time of the main scanning operation.

As described above, in the present example, the linear scale 322 of the linear encoder 306 and the sensor 324 can be considered to be included in the main scan drive unit 18. However, depending on the way of dividing the configuration of the shaping device 10, the sensor 324 of the linear scale 322 can also be considered as the configuration of the head part 12 or the ink ejection unit 102, and the like. Instead of using the linear encoder 306 as a member separate from the guide rail 302, it is also conceivable to use the guide rail 302 having the function of a linear encoder.

As described above, according to the present example, each configuration of the head part 12 can be appropriately moved in the main scanning direction at the time of the main scanning operation. Furthermore, the miniaturization and weight reduction of the carriage 202 can be appropriately realized by using the head units 204a and 204b for the ink ejection unit 102 of the head part 12. In this case, the Y bar structure, which is a portion extending in the main scanning direction in the main scan drive unit 18, can be appropriately simplified in accordance with the carriage 202 that has been reduced in size and weight. Furthermore, in this case, by holding the flattening roller unit 104 and the light source unit 106 independently of the ink ejection unit 102 by the guide rail 302, even if the Y bar structure is simplified, the bending and the like of the guide rail 302 can be appropriately prevented, and each configuration of the head part 12 can be appropriately supported.

Furthermore, at the time of the main scanning operation, it is necessary to control the timing of ejecting the ink from the ink ejection unit 102 with high accuracy. Therefore, at the time of the main scanning operation, the position of the ink ejection unit 102 is particularly important among the positions of each configuration of the ink ejection unit 102. On the other hand, the accuracy required at the position in the main scanning direction of the flattening roller unit 104 and the light source unit 106 can be said to be lower than that of the ink ejection unit 102. Therefore, in the present example, as described above, the carriage 202 is moved by the belt 312 while the position of the carriage 202 of the ink ejection unit 102 is detected by the linear encoder 306. The flattening roller unit 104 and the light source unit 106 are moved according to the movement of the carriage 202. Therefore, according to the present example, the position of the ink ejection unit 102 in the main scanning direction can be appropriately controlled with high accuracy.

Furthermore, in the present example, the flattening roller unit 104 is arranged outside the carriage 202 of the ink ejection unit 102, and the carriage 202 and the flattening roller unit 104 are connected in a predetermined configuration, so that the adjustment of the inclination of the carriage 202 and the adjustment of the height of the flattening roller 402 of the flattening roller unit 104 can be more easily and appropriately carried out. The manner of connecting the flattening roller unit 104 and the carriage 202 will be described in more detail below.

In a case where the flattening roller is also held by the carriage 202 of the ink ejection unit 102, when the adjustment of changing the inclination of the carriage 202 is performed, the height of the flattening roller in the vertical direction also directly changes. In this case, the inclination of the carriage 202 can be considered as an inclination with respect to the horizontal direction of a surface facing the shaping table 14 (see FIG. 1) in the carriage 202. The inclination with respect to the horizontal direction can also be considered as an inclination with respect to the horizontal plane. The height of the flattening roller can be considered as the height at which flattening is performed in the flattening roller (position in the vertical direction). On the other hand, when the flattening roller unit 104 is arranged outside the carriage 202 as in the present example, it is possible to make it difficult to directly affect the height of the flattening roller 402 of the flattening roller unit 104 when adjusting the inclination of the carriage 202. Furthermore, even in a case of adjusting the height of the flattening roller 402, it is possible to make the direct influence on the inclination of the carriage 202 less likely to occur when adjusting the height of the flattening roller 402.

In this regard, as described above, in the present example, the flattening roller unit 104 is connected to the carriage 202 of the ink ejection unit 102 by the attraction force of the magnet, thereby being connected to the carriage 202. In this case, as compared with a case where the positional relationship between the flattening roller unit 104 and the carriage 202 is firmly fixed by screwing or the like, a change in one of the inclination of the carriage 202 and the height of the flattening roller 402 hardly affects the other. The manner of connecting the carriage 202 and the flattening roller unit 104 can also be considered as connecting them in a state where the flattening roller unit 104 moves together with the carriage 202 when the carriage 202 is moved along the guide rail 302, and fine adjustment of the inclination, height, or the like of one of the carriage 202 and the flattening roller unit 104 can be performed without moving the other.

As described above, in the present example, the flattening roller unit 104 is supported by the guide rail 302 by itself independently of the carriage 202 of the ink ejection unit 102. The flattening roller unit 104 is connected to the carriage 202 by the attraction force of the magnet. The connection by the attraction force of the magnet can be considered as loose joining as compared with fixing by screwing or the like. Therefore, as long as the inclination of the carriage 202 is adjusted, the adjustment with respect to the carriage 202 can be appropriately performed while appropriately suppressing the influence on the height of the flattening roller 402 of the flattening roller unit 104. On the contrary, the height of the flattening roller 402 can be adjusted by changing the position of the flattening roller unit 104 while suppressing the influence on the inclination and the like of the carriage 202. Therefore, according to the present example, the adjustment of the inclination of the carriage 202, the adjustment of the height of the flattening roller 402, and the like can be more appropriately performed independently of each other. In addition, this makes it possible to easily and appropriately perform these adjustments with high accuracy.

Furthermore, in the present example, the flattening roller unit 104 is connected to the carriage 202 by the attraction force of the magnet, so that the position of the flattening roller 402 in the vertical direction can be adjusted without changing the inclination of the carriage 202 with respect to the horizontal direction. In this case, the fact that the position of the flattening roller 402 in the vertical direction can be adjusted without changing the inclination of the carriage 202 with respect to the horizontal direction can also be considered as not changing the inclination of the carriage 202 when the adjustment amount of the position of the flattening roller 402 is within a predetermined range. Furthermore, not changing the inclination of the carriage 202 can also be considered as not substantially changing the inclination of the carriage 202 according to the accuracy of shaping required at the time of shaping. The fact that the inclination of the carriage 202 is not substantially changed can also be considered that the shaping can be performed without re-adjusting the inclination of the carriage 202. According to such configuration, the height of the flattening roller 402 can be appropriately adjusted without affecting the inclination of the carriage 202. Thus, the height of the flattening roller 402 can be more appropriately adjusted with a high degree of freedom.

Furthermore, in this case, it is conceivable to execute the adjustment of the position of the flattening roller 402 by adjusting the entire position of the flattening roller unit 104. The adjustment of the entire position of the flattening roller unit 104 can be considered as an adjustment of changing the relative position of the flattening roller unit 104 with respect to the carriage 202. The position of the flattening roller 402 may be adjusted (for example, fine adjustment) by changing the position of the flattening roller 402 in the vertical direction by the driving force of the motor 406. In this case, it is conceivable to further adjust the position of the flattening roller 402 in the vertical direction by the driving force of the motor 406 after adjusting the entire position of the flattening roller unit 104. According to such configuration, the height of the flattening roller 402 can be more appropriately adjusted with high accuracy.

The flattening roller unit 104 can also be considered to be connected to the carriage 202 by the attraction force of the magnet so that the inclination of the carriage 202 with respect to the horizontal direction can be adjusted without changing the position of the flattening roller 402 in the vertical direction by being connected to the carriage 202. In this case, the fact that the inclination of the carriage 402 with respect to the horizontal direction can be adjusted without changing the position of the flattening roller 202 can also be considered as not changing the position of the flattening roller 402 when the adjustment amount of the inclination of the carriage 202 is within a predetermined range. Not changing the position of the flattening roller 402 can also be considered as not substantially changing the position of the flattening roller 402 according to the required accuracy of shaping at the time of shaping. The fact that the position of the flattening roller 402 is not substantially changed can also be considered that the shaping can be performed without re-adjusting the position of the flattening roller 402. According to such configuration, the adjustment of the inclination of the carriage 202 can be appropriately performed without affecting the height of the flattening roller 402. Furthermore, the inclination of the carriage 202 can be more appropriately adjusted with a high degree of freedom.

Subsequently, supplementary explanation or the like regarding each configuration described above will be made. In the above description, the case of arranging the plurality of head units 204a and 204b held by the carriage 202 of the ink ejection unit 102 in the main scanning direction with the positions in the sub scanning direction aligned has been mainly described. In the modification of the head part 12, the arrangement of the plurality of head units 204a and 204b may be different from the above. In this case, it is conceivable to hold the plurality of head units 204a and 204b arranged by shifting the positions in the sub scanning direction by the carriage 202. In the description made above, the case where the number of head units held by the carriage 202 in the ink ejection unit 102 is two has been mainly described. In a modification of the head part 12, the number of head units held by the carriage 202 may be three or more. In this case as well, the difference in the consumption amount can be appropriately reduced for the inks of a plurality of colors ejected from one head unit by ejecting the ink of each color of YMCK from one head unit and ejecting the ink of another color from another head unit.

As described above, in the head part 12 of the present example, the flattening roller unit 104 is disposed outside the carriage 202 of the ink ejection unit 102. In this case, various effects can be obtained in addition to the matters described above. As described above, at the time of the main scanning operation, the flattening roller 402 of the flattening roller unit 104 rotates according to the driving force of the motor 404 in a state of being in contact with the layer of ink. In this case, the flattening roller 402 rotates while receiving the force due to the contact, so that minute vibration and the like are likely to occur. Therefore, when the flattening roller 402 is held by the carriage 202 together with the head units 204a and 204b, the head units 204a and 204b are easily affected by vibration or the like generated at the position of the flattening roller 402. Furthermore, as a result, it is conceivable that the accuracy of ink ejection in the head units 204a and 204b is affected. On the other hand, in the present example, as described above, the flattening roller unit 104 is disposed outside the carriage 202, and the carriage 202 and the flattening roller unit 104 are connected by the attraction force of the magnet. According to such configuration, the influence of the vibration and the like generated at the position of the flattening roller 402 can be appropriately prevented from reaching the head units 204a and 204b. Thus, the ink can be more appropriately ejected with high accuracy in the head units 204a and 204b.

Furthermore, as described above, in the drive mechanism 304 of the main scan drive unit 18 of the present example, the belt 312 is not directly connected to the flattening roller unit 104 and the light source unit 106. In this case, since the flattening roller unit 104 is not directly connected to the belt 312, adjustment of the position and the like can be considered to be easy. Therefore, it can be considered that it is particularly preferable that the flattening roller unit 104 is not directly connected to the belt 312. On the other hand, in the case of the light source unit 106, since the weight is larger than that of the flattening roller unit 104, it is also conceivable to fix the light source unit to the belt 312. According to such configuration, the light source unit 106 can be more reliably held in the main scan drive unit 18.

In the description made above, the configuration in which the flattening roller unit 104 is arranged on one side of the ink ejection unit 102 in the main scanning direction has been mainly described. In a modification of the head part 12, the flattening roller unit 104 may be disposed on both sides of the ink ejection unit 102 in the main scanning direction. According to such configuration, when forming the layer of ink by the reciprocating main scanning operation, the layer of ink can be flattened in both the forward path and the backward path. When the flattening roller unit 104 is disposed outside the carriage 202 of the ink ejection unit 102 as in the present example, the attachment and detachment of the flattening roller unit 104 can be more easily performed. Thus, the position of arranging the flattening roller unit 104 may be switched to only one side or both sides of the ink ejection unit 102 according to the quality and the like required for shaping.

Furthermore, in the description made above, the configuration of joining the carriage 202 and the flattening roller unit 104 by the attraction force of the magnet has been mainly described for the connection of the carriage 202 of the ink ejection unit 102 and the flattening roller unit 104. In a modification of the head part 12, the carriage 202 and the flattening roller unit 104 may be coupled by a method other than the attraction force of the magnet. In this case as well, similarly to the configuration described above, it is preferable to use a configuration in which the flattening roller unit 104 moves together with the carriage 202 at the time of the main scanning operation, and the inclination of the carriage 202 and the height of the flattening roller 402 can be appropriately adjusted.

Considering from the viewpoint of miniaturization and weight reduction of the carriage 202, the flattening roller 402 is not necessarily provided outside the carriage 202, and it is also conceivable to hold the flattening roller 402 together with the head units 204a and 204b in the carriage 202. Even with such a configuration, the use of the head units 204a and 204b makes it possible to reduce the size and weight of the carriage 202.

### Industrial Applicability

The present invention can be suitably used in a shaping device.

### REFERENCE SIGNS LIST

10 Shaping device
102 Ink ejection unit
104 Flattening roller unit
106 Light source unit
112 Connecting unit
12 Head part
14 Shaping table
152 Light reflecting region
154 Coloring region
16 Ink tank
18 Main scan drive unit
20 Shaping table drive unit
202 Carriage
204 Head unit
212 Nozzle row
22 Control unit
302 Guide rail
304 Drive mechanism
306 Linear encoder
312 Belt
314 Driving pulley
316 Driven pulley
318 Motor
322 Linear scale
324 Sensor
402 Flattening roller
404 Motor
406 Motor
50 Shaped object
52 Support layer

1. A shaping device that shapes a shaped object, in which at least a part is colored, by overlapping layers of ink, the shaping device comprising:
a plurality of head units, each of the plurality of head units eject ink from a plurality of nozzle rows; and
a carriage that holds the plurality of head units, wherein
each of the plurality of head units include the plurality of nozzle rows, each of the plurality of nozzle rows eject ink supplied from an ink container via different ink supply paths, and
the plurality of head units comprises:
a first head unit including a first set of plurality of nozzle rows each of which ejects colored ink of different colors; and
a second head unit including a second set of plurality of nozzle rows each of which ejects ink different from the colored ink ejected by the first head unit.

2. The shaping device as set forth in claim 1, wherein
each of the plurality of head units is a component of a unit of replacement to be collectively replaced when any one of the nozzle rows fails, and
in each head unit, the plurality of nozzle rows are arranged while maintaining a predetermined positional relationship.

3. The shaping device as set forth in claim 1, wherein
the shaped object is shaped which includes:
a light reflecting region formed using an ink of a light reflective color; and
a coloring region formed on an outer side of the light reflecting region using the colored ink,
the coloring region is a region formed using the colored inks of a plurality of colors and a clear ink,
each of the plurality of nozzle rows in the first head unit ejects each of the colored inks of the plurality of colors used for forming the coloring region, and
the second head unit includes, as at least a part of the plurality of nozzle rows:
a nozzle row that ejects the light reflective ink;
a nozzle row that ejects the clear ink; and
a nozzle row that ejects ink to become a material of a support layer that supports at least a part of the shaped object when shaping the shaped object.

4. The shaping device as set forth in claim 3, wherein the coloring region is a region formed only with the colored ink of the plurality of colors ejected from the first head unit and the clear ink ejected from the second head unit.

5. The shaping device as set forth in claim 1, further comprising:
a main scan drive unit that causes the plurality of head units to perform a main scanning operation of ejecting ink while moving in a main scanning direction set in advance; and
a flattening means that includes a flattening roller that flattens a layer of the ink, wherein
the main scan drive unit includes:
a guide member that guides movement of the carriage in the main scanning direction; and
a drive mechanism that moves the carriage along the guide member, and
the flattening means is held by the guide member so as to be movable in the main scanning direction outside the carriage.

6. A maintenance method for a shaping device that performs maintenance on the shaping device as set forth in claim 1, the method comprising:
prompting a user to replace each of the head units based on an operating amount at which the shaping device operates; and
urging the user to replace each of the head units such that the second head unit is replaced more frequently than the first head unit by setting the first head unit and the second head unit differently from each other in association between the operating amount and a replacement timing.

7. A shaping method for shaping a shaped object in which at least a part is colored by overlapping layers of ink, the shaping method comprising:
using a plurality of head units each of which ejects ink from a plurality of nozzle rows, and a carriage that holds the plurality of head units, each of the plurality of head units including the plurality of nozzle rows that eject ink supplied from an ink container via different ink supply paths;
holding, by the carriage, as the plurality of head units,
a first head unit including the plurality of nozzle rows each of which ejects colored inks of different colors;
a second head unit including the plurality of nozzle rows each of which ejects ink different from the colored ink ejected by the first head unit; and
ejecting ink from the first head unit and the second head unit to shape the shaped object.

8. The shaping device as set forth in claim 2, wherein
the shaped object is shaped which includes:
a light reflecting region formed using an ink of a light reflective color; and
a coloring region formed on an outer side of the light reflecting region using the colored ink,
the coloring region is a region formed using the colored inks of a plurality of colors and a clear ink,
each of the plurality of nozzle rows in the first head unit ejects each of the colored inks of the plurality of colors used for forming the coloring region, and
the second head unit includes, as at least a part of the plurality of nozzle rows:
a nozzle row that ejects the light reflective ink;
a nozzle row that ejects the clear ink; and
a nozzle row that ejects ink to become a material of a support layer that supports at least a part of the shaped object when shaping the shaped object.

9. The shaping device as set forth in claim 2, further comprising:
a main scan drive unit that causes the plurality of head units to perform a main scanning operation of ejecting ink while moving in a main scanning direction set in advance; and
a flattening means that includes a flattening roller that flattens a layer of the ink, wherein
the main scan drive unit includes:
a guide member that guides movement of the carriage in the main scanning direction; and
a drive mechanism that moves the carriage along the guide member, and
the flattening means is held by the guide member so as to be movable in the main scanning direction outside the carriage.

10. The shaping device as set forth in claim 3, further comprising:
a main scan drive unit that causes the plurality of head units to perform a main scanning operation of ejecting ink while moving in a main scanning direction set in advance; and
a flattening means that includes a flattening roller that flattens a layer of the ink, wherein
the main scan drive unit includes:
a guide member that guides movement of the carriage in the main scanning direction; and
a drive mechanism that moves the carriage along the guide member, and
the flattening means is held by the guide member so as to be movable in the main scanning direction outside the carriage.

11. The shaping device as set forth in claim 4, further comprising:
a main scan drive unit that causes the plurality of head units to perform a main scanning operation of ejecting ink while moving in a main scanning direction set in advance; and
a flattening means that includes a flattening roller that flattens a layer of the ink, wherein
the main scan drive unit includes:
a guide member that guides movement of the carriage in the main scanning direction; and
a drive mechanism that moves the carriage along the guide member, and
the flattening means is held by the guide member so as to be movable in the main scanning direction outside the carriage.
